(19) United States
(12) Patent Application Publication
(10) Pub. No.: US 2002/0079679 A1
(43) Pub. Date: Jun. 27, 2002

(54) Automatic impact severity compensation system

(76) Inventors: Karsten E. Thiele, West Bloomfield, MI (US); Gary M. Peteuil, Rochester Hills, MI (US)

Correspondence Address: MICHAEL BEST & FRIEDRICH, LLP, 100 E WISCONSIN AVENUE, MILWAUKEE, WI, 53202, US

(21) Appl. No.: 09/748,491

(22) Filed: Dec. 26, 2000

(51) Int. Cl. B60R 21/32

(52) U.S. Cl. 280/735

(57) ABSTRACT

A method and apparatus for adjusting the impact of an airbag on an occupant. The apparatus includes a programmable controller programmed to generate a control signal based on information from a pressure sensor located within an inflation structure. The programmable controller is coupled in data communication to a gas flow generator and controller. The gas flow generator and controller has a valve to control the direction of gas flow into the inflation structure based on the control signal from the programmable controller. The programmable controller is programmed to continuously monitor the output signal of the pressure sensor and adjust the control signal based on the output signal of the pressure sensor. In one embodiment, the control signal is a pulse-width modulated signal and the valve is controlled such that inflation of various parts of the air bag is adjusted to control the severity of the impact of the air bag on the occupant. Preferably, the gas flow generator and controller has a second or combined valve that controls the quantity of gas flow to the airbag and the programmable controller generates a second control signal to control the second or combined valve. The second control signal can be adjusted such that the valve is operated to modulate, increase, decrease, or stop gas flow to the airbag.

The invention also includes a method of controlling the severity of the impact of an airbag on a vehicle occupant. The method includes sensing a vehicular collision and enabling an inflatable structure having a plurality of portions; initiating the inflation of the inflatable structure; obtaining a plurality of pressure measurements of pressure values within the inflatable structure as it inflates; comparing the pressure measurements with predetermined criteria; and controlling the direction of gas flow into the inflation structure such that inflation of different portions of the inflatable structure is adjusted based on the comparison between the pressure measurements and the predetermined criteria.

### BACKGROUND OF THE INVENTION

The present invention relates to methods and systems designed to protect occupants of vehicles in the event of a vehicle collision. More specifically, the invention relates to an impact severity compensation system that adjusts the inflation of an air bag (or, more broadly, an inflatable occupant restraint device) based on the inner pressure of the air bag.

Injuries to vehicle occupants are not caused directly by the collision of the vehicle with another object, but by the collision of the occupants with the interior of the vehicle or by the occupants being ejected from the vehicle. Modem automobiles and similar vehicles such as vans and trucks are equipped with occupant restraint systems such as safety belts and air bag systems to prevent interior collisions and ejections. As is known, air bag systems are activated when a vehicle is involved in a collision. Sensors mounted in the vehicle sense the occurrence of a collision and send a signal to a controller, which then sends a control signal to an air bag causing it to deploy. The air bag is designed to rapidly inflate and provide a cushioning and restraining surface to the occupant located near the air bag. While air bag systems have greatly enhanced the safety of vehicles, they are not completely satisfactory.

As has been highly publicized, many air bag systems inflate with such rapidity and force that lightweight or small occupants can be injured, sometimes fatally. To address this problem a number of enhanced air bag systems have been developed. For example, at least one manufacturer has developed an air bag system that senses the occupancy state of the vehicle interior to determine the classification of the object or individual seated in the vehicle. The system can distinguish between the presence of rear-facing and forward-facing child seats; the presence of a large child or small adult; and the presence of an average size or larger adult. Based upon the occupancy state of the vehicle, the system determines whether to enable or disable the vehicle air bag. In addition, the inflation of the air bag may be modified by controlling the number of gas cartridges that are used to inflate the air bag to compensate for the type of individual seated in the vehicle. Although the system is an improvement over early air bag systems, it is relatively complex and expensive. Further, the system is not specifically designed to adjust the deployment of the air bag system based on the impact of the airbag on the occupant.

Other systems such as the one disclosed in U.S. Pat. No. 5,769,452, issued to Yoshida, are designed to decrease or stop the flow of gas into an air bag when an occupant is positioned so near the airbag that normal deployment of the airbag would cause injury to the occupant. The system described by Yoshida senses the internal pressure of the airbag and adjusts the inflation of the bag when the internal pressure reaches predetermined levels. In the Yoshida system, it is assumed that contact between the airbag and an out-of-position occupant (for example, an occupant sitting close to the vehicle dashboard) causes higher than normal pressures or increases in pressure within the airbag as it is deployed. Although the Yoshida system adjusts airbag deployment based on the impact of the air bag on the occupant, the Yoshida system controls only the amount of gas used to inflate the air bag.

### SUMMARY OF THE INVENTION

The inventors have determined that the ability to control the amount and direction of gas flow in an airbag is important to inflating an air bag such that the air bag does not impact the vehicle occupant so severely as to cause injury to the occupant. Accordingly, there is a need for an improved air bag deployment system that adjusts inflation gas direction and quantity. The present invention includes an apparatus having a programmable controller programmed to generate a control signal based on a signal from a pressure sensor located within an inflation structure. An exemplary inflation structure is an air bag, such as a chambered air bag or a shaped air bag. The programmable controller is coupled in data communication to a gas flow generator and controller. The gas flow generator and controller has a valve to control the direction of gas flow into the inflation structure based on the control signal from the programmable controller. The programmable controller is programmed to continuously monitor the output signal of the pressure sensor and adjust the control signal based on the output signal of the pressure sensor. In one embodiment, the control signal is a pulse-width modulated signal and the valve is controlled such that inflation of various parts of the air bag is adjusted to control the severity of the impact of the air bag on the occupant. Preferably, the gas flow generator and controller has a second or combined valve that controls the quantity of gas flow to the airbag and the programmable controller generates a second control signal to control the second or combined valve. The second control signal can be adjusted such that the valve is operated to modulate, increase, decrease, or stop gas flow to the air bag.

The programmable controller is programmed to compare the actual pressure sensed in the air bag by the pressure sensor with a reference pressure and control the direction and amount of airflow to reduce sever impact of the air bag on an occupant. The programmable controller can also be programmed to compare actual pressure rate measurements with reference pressure rate measurements. Preferably, the programmable controller takes into consideration the measured pressure over time as compared to preset limits, the measured maximum pressure as compared to preset limits, the inflatable structure specifications and characteristics (such as size, shape, material, design, and the like) and the inflation environment application depending on the geometrical measures that the inflation structure has to cover, the preferred sequence of the inflation of the structure itself, the allowable impact severity of the inflation structure on the occupant or object, the deployment strategy understood as actively pushing the occupant or object to a predetermined position or keeping the object or occupant at its current position, other existing inflation structures, etc.

The invention also includes a method of controlling the severity of the impact of an air bag on a vehicle occupant. The method includes sensing a vehicular collision and enabling an inflatable structure having a plurality of portions; initiating the inflation of the inflatable structure; obtaining a plurality of pressure measurements of pressure values within the inflatable structure as it inflates; comparing the pressure measurements with predetermined criteria; and controlling the direction of gas flow into the inflation structure such that the inflation of different portions of the inflatable structure is adjusted based on the comparison between the pressure measurements and the predetermined criteria.

As is apparent from the above, it is an advantage of the present invention to provide an apparatus and method of controlling the collision between an occupant and an air bag. Other features and advantages of the present invention will become apparent by consideration of the detailed description and accompanying drawings.

### BRIEF DESCRIPTION OF THE DRAWINGS

In the drawings:

FIG. 1 is a schematic diagram of an apparatus embodying the invention.

FIG. 2 is a schematic diagram of a gas flow generator and controller suitable for use in the invention.

FIG. 3 is a schematic diagram of another gas flow generator and controller suitable for use in the invention.

### DETAILED DESCRIPTION

Before one embodiment of the invention is explained in detail, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

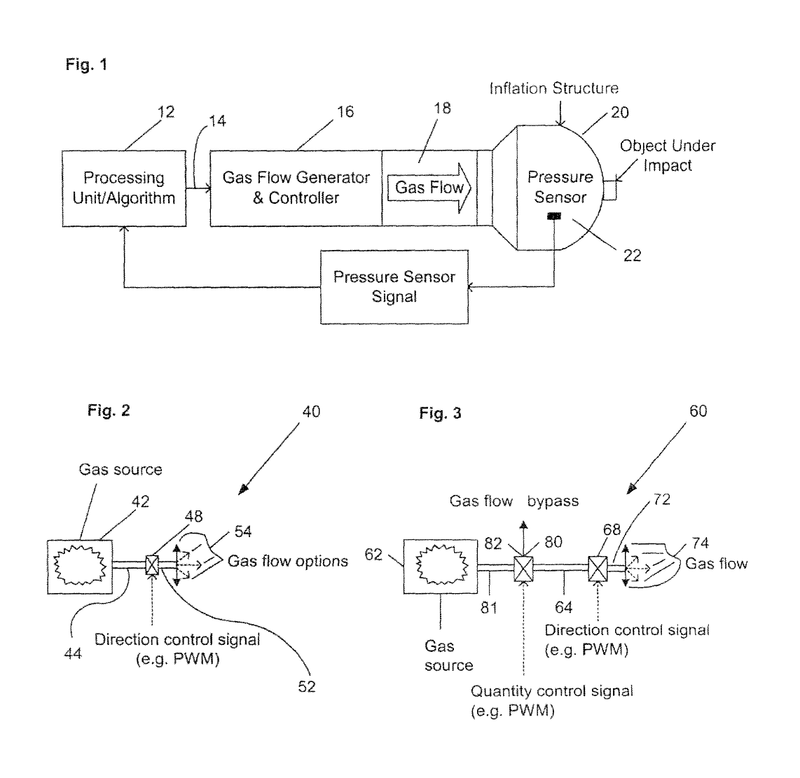

An apparatus 10 embodying the invention is shown in FIG. 1. The apparatus 10 includes a processing unit or programmable controller 12 that produces output signals that are transmitted over data link 14. The data link 14 is coupled to a gas flow generator and controller 16. As will be discussed in greater detail below, the gas flow generator and controller 16 includes a gas source and a directional control such as a valve. The directional control receives a control signal from the programmable controller 12. The gas flow generator and controller 16 generates a gas flow, as depicted by the arrow 18. The gas flow generator and controller 16 is coupled in fluid communication to inflation structure 20, which receives the gas flow 18. The inflation structure 20 may be a multiple-chamber air bag, shaped air bag, or similar device.

A pressure sensor 22 is located within the inflation structure 20. The pressure sensor 22 generates an output signal that is fed to the programmable controller 12. The pressure sensor 22 senses the pressure within the inflation structure. The pressure within the inflation structure 20 changes as it is inflated and as it impacts objects or occupants within the interior of a vehicle (not shown). As was discussed above, an occupant positioned in close proximity to the inflation structure housing may be injured due to rapid and forceful air bag deployment. It has been observed through empirical testing that the collision of an out-of-position occupant with an airbag causes pressure increases within the airbag as compared to the inflation and impact of a properly positioned occupant with an airbag. As will be discussed in greater detail below, the controller 12 is programmed to adjust the inflation of the inflation structure 20 based on the pressure measurements made by the pressure sensor. The pressure sensor 22 and controller 12 can be configured such that the system 10 determines changes in pressure or changes in the rate of pressure change.

In one embodiment, the programmable controller 12 continuously monitors the pressure information from the pressure sensor 22 and generates one or more control signals that are delivered to the gas flow generator and controller 16. The gas flow generator and controller adjusts the inflation of the inflation structure 20 to prevent a severe impact with an occupant.

FIG. 2 illustrates one embodiment of the gas flow generator and controller; a gas flow generator and controller 40. The gas flow generator and controller 40 has a gas source 42, a gas conduit 44, a directional valve 48, and a nozzle 52. The gas source 42, gas conduit 44, and nozzle 52 are conventional components. The directional valve receives a control signal from the programmable controller 12. Preferably, the control signal is a pulse-width modulated signal. Depending on the exact signal received by the valve, the valve directs the gas flow to one or more locations 54. It is envisioned that each location may be connected to an individual chamber of a multiple-chamber inflation structure. Thus, by controlling the direction of gas flow to the inflation structure the compartments or parts of the air bag may be selectively inflated to adjust the impact of the air bag on the occupant.

FIG. 3 illustrates another embodiment of the gas flow generator and controller, a gas flow generator 60. The gas flow generator and controller 60 has many components that are identical to those in the gas flow generator and controller 40. These components include a gas source 62, a gas conduit 64, a direction control valve 68, and a nozzle 72. The direction control valve 68 directs gas flow to a plurality of locations 74. The control of gas flow direction in the gas flow generator and controller 60 is achieved in substantially the same manner as in the gas flow generator and controller 40. However, in addition to control of gas flow direction, the gas flow generator and controller 60 provides control of gas flow quantity with a second valve 80. The second valve 80 is coupled to the gas source through a conduit 81 and is controlled by a second control signal from the programmable controller 12. The second valve 80 can modulate, increase, decrease, or stop the flow of gas to the inflation structure 20. To stop gas flow to the inflation structure 20, the valve 82 is equipped with by-pass 82 to vent the gas flow to a space outside the inflation structure.

It should be understood that the second valve 80 could be made integral with, positioned in a common housing, or physically combined with the directional valve 48 to form a combined valve (not shown). Regardless of its exact form, the concept is to have a mechanism to control flow quantity and direction. Further, while it may be possible to have a single signal control both valves, such as by multiplexing quantity and direction information, some technique would have to be employed to provide both pieces of information (direction and quantity) to the valves 48 and 80 or a combined version thereof.

As can be seen from the above, the invention provides an apparatus and method of adjusting the inflation of an airbag to control the severity of the impact of the air bag on the occupant.

Various features and advantages of the invention are set forth in the following claims.

What is claimed is:

1. An impact severity compensation apparatus comprising:
a controller operable to generate a control signal;
an inflation structure;
a gas flow generator and controller coupled in data communication to the programmable controller and coupled in fluid communication to the gas flow generator and controller, the gas flow generator and controller having a valve to control the direction of gas flow into the inflation structure based on the control signal from the programmable controller; and
a pressure sensor positioned in the inflation structure and operable to generate an output signal, the pressure sensor coupled in data communication to the controller;
wherein the controller continuously monitors the output signal of the pressure sensor and adjusts the control signal based on the output signal of the pressure sensor.

2. The apparatus as claimed in claim 1, wherein the controller is a programmable controller.

3. The apparatus as claimed in claim 1, wherein the control signal is a pulse width modulated signal.

4. The apparatus as claimed in claim 1, wherein the gas flow generator and controller includes a second valve to control the quantity of gas to the inflatable structure and the programmable controller generates a second control signal to control the second valve.

5. The apparatus as claimed in claim 4, wherein the second control signal is a pulse width modulated signal.

6. The apparatus as claimed in claim 1, wherein the inflation structure is an air bag.

7. A method of controlling the severity of the impact of an air bag on a object within an interior of a vehicle, the method comprising:
sensing a vehicular collision and enabling an inflatable structure having a plurality of portions;
initiating the inflation of the inflatable structure;
obtaining a plurality of pressure measurements of pressure values within the inflatable structure as it inflates;
comparing the pressure measurements with predetermined criteria; and
controlling the direction of gas flow into the inflation structure such that inflation of different portions of the inflatable structure is adjusted based on the comparison between the pressure measurements and the predetermined criteria.

8. The method as claimed in claim 7, wherein controlling the direction of gas flow includes generating a control signal.

9. The method as claimed in claim 8, wherein controlling the direction of gas flow includes modulating the control signal.

10. The method as claimed in claim 7, further comprising controlling the quantity of gas flow to the inflatable structure.

11. The method as claimed in claim 10, wherein controlling the quantity of gas flow includes generating a second control signal.

12. The method as claimed in claim 11, wherein controlling the quantity of gas flow includes modulating the second control signal.

13. An impact severity compensation apparatus comprising:
a programmable controller operable to generate a control signal;
a multiple-chamber air bag having a plurality of chambers;
a gas flow generator and controller coupled in data communication to the programmable controller and coupled in fluid communication to the gas flow generator and controller, the gas flow generator and controller having a valve to control the direction of gas flow into the air bag based on the control signal from the programmable controller; and
a pressure sensor positioned in the air bag and operable to generate an output signal, the pressure sensor coupled in data communication to the programmable controller;
wherein the programmable controller is programmed to continuously monitor the output signal of the pressure sensor and adjust the control signal based on the output signal of the pressure sensor.

14. The apparatus as claimed in claim 13, wherein the control signal is a pulse width modulated signal.

15. The apparatus as claimed in claim 13, wherein the gas flow generator and controller includes a second valve to control the quantity of gas to the air bag and the programmable controller generates a second control signal to control the second valve.

16. The apparatus as claimed in claim 15, wherein the second control signal is a pulse width modulated signal.

17. A method of controlling the severity of the impact of an air bag on a object within an interior of a vehicle, the method comprising:
sensing a vehicular collision and enabling a gas source;
initiating the inflation of a multiple-chamber air bag;
obtaining a plurality of pressure measurements of pressure values within the air bag as it inflates;
comparing the pressure measurements with predetermined criteria; and
controlling the direction of gas flow into the air bag such that inflation of different chambers of the air bag is adjusted based on the comparison between the pressure measurements and the predetermined criteria.

18. The method as claimed in claim 17, wherein controlling the direction of gas flow includes generating a control signal.

19. The method as claimed in claim 18, wherein controlling the direction of gas flow includes modulating the control signal.

20. The method as claimed in claim 17, further comprising controlling the quantity of gas flow to the inflatable structure.

21. The method as claimed in claim 20, wherein controlling the quantity of gas flow includes generating a second control signal.

22. The method as claimed in claim 21, wherein controlling the quantity of gas flow includes modulating the second control signal.
